(19) United States
(12) Patent Application Publication
(10) Pub. No.: US 2006/0165252 A1
(43) Pub. Date: Jul. 27, 2006

(54) Speaker vibrating member

(76) Inventor: Hiroshi Ohara, Tao-Yuan Hsien (TW)

Correspondence Address: LIN & ASSOCIATES INTELLECTUAL PROPERTY, P.O. BOX 2339, SARATOGA, CA, 95070-0339, US

(21) Appl. No.: 11/041,428

(22) Filed: Jan. 22, 2005

(51) Int. Cl. H04R 9/06

(52) U.S. Cl. 381/426; 381/423

(57) ABSTRACT

Speaker vibration members that can generate negative ions are provided. The present invention is characterized in that the fabric material for making vibrating member of loud speaker, such as spider, diaphragm, or baffle gasket, are enriched in negative ions solution before press forming into respective shapes and structures. When the negative ion enriched vibrating member is installed in a speaker, the audio output through the speaker will cause these vibration members to vibrate and distribute negative ions into the surrounding air. Since the negative ions have a positive effect on the environment by neutralizing odors, these ions contribute to the clean air and fresh smell in the environment.

### BACKGROUND OF THE INVENTION

1. Field of the Invention

The present invention relates to vibrating member in a loud speaker, and in particular to speaker vibrating member, such as spider, diaphragm, or baffle gasket, installable in telephones, hand phones, walkmans, digital audio devices that is capable of producing negative ions in the air.

2. The Related Art

Conventional moving coil speakers include the following components: a speaker driver, a diaphragm, and a suspension system. The speaker driver is composed of a field magnet, pole pieces, pole plates, an air gap, and a voice coil unit. The diaphragm or speaker cone is the actual component that is responsible for converting the electrical signals into audible sound. The suspension system is composed of a spider and a baffle gasket, where the spider is responsible for damping the motion of the speaker cone in a longitudinal direction. The speaker driver, speaker cone and suspension system are housed in a cone housing. The voice coil is connected by lead wire to a terminal that is disposed on the outer peripheral wall of the cone housing.

When an electrical signal is passed through the terminal and the lead wire to the voice coil, a magnetic field is created in response to the input signal, which is perpendicular to the line of force of the electromagnet, so the voice coil attached speaker cone travels through the air gap longitudinally. The movement of the speaker cone displaces the air in the vicinity of the cone, and creates sound waves having an amplitude and frequency to match the electrical signals. In this manner the desired audible sound reproduction is achieved.

The non-metal parts in the loud speaker are made from cloth or fabric material. The main reason for choosing fabric material is that it possesses that kind of resilience and tenacity required for the vibrating member such as spider, diaphragm, or baffle gasket.

Speaker vibrating members are commonly installed in audio equipment, telephone sets, mobile phones, walkman radios, and digital audio devices to reproduce audio effects. The speaker cone displaces the air to produce sound waves through the air. The conventional spider is only used for damping in the loud speaker. However, these vibrating members can be modified for other more creative applications, such as air purification. For example, a spider or speaker cone can be modified to be able to generate negative ions as it vibrates.

### SUMMARY OF THE INVENTION

The primary objective of the present invention is to provide speaker vibrating member, such as spider, diaphragm, or baffle gasket, installable in telephones, hand phones, walkmans, digital audio devices that can generate negative ions in the air.

In the fabrication of the vibrating member, the fabric material for making the vibrating member is impregnated in a solution enriched with negative ions, which is specially prepared from nanoparticles and powder materials. The soaked fabric sheet is passed through rollers and baked. Finally, the fabric sheet is placed in a press mould to produce a vibrating member with required shape and structure.

When enough energy acts on a molecule such as carbon dioxide, oxygen, water, and nitrogen, these molecules give out electrons. The displaced electrons attach themselves to nearby molecules, which then become negative ions. These molecules with extra electrons have a positive effect on the environment, as they can neutralize odors and contribute to the clean air and fresh smell that are commonly found in sparsely populated areas. The original molecules giving up electrons are now positive ions. Once these negative ions react with dust and pollutants, the ions are neutralized, that is why negative ions quickly vanished.

Generally, about half of the negative ions in the environment are created by radioactive gases, and the other half are produced by radioactive substances in the soil, cosmic rays, ultraviolet rays, air flow, falling water and plants.

Sometimes, the negative ions are referred to as “vitamins of the air”, because of their beneficial effect on the humans. Since the negative ions are also related to regeneration of youthfulness and longevity, they are also called “the longevity pills”.

The density of negative ions is usually higher in the natural environment, such as parks, open fields, lakes, waterfalls and forests. An invigorating sensation can be created if a person inhales the air carrying enough negative ions, but car exhausts, factory fumes, dust, cigarette smokes, cooking fumes and soot will absorb the negative ions.

Scientists who have been doing researches on this topic have discovered that the negative ions are beneficial to the humans in several ways:

(1) The neural system: Negative ions can promote activation of the brain cells and stimulate cell activities in the cerebral cortex, so this can help a person improve the work efficiency and sleep calmly. The negative ions pass through cerebrovascular tissues to the cerebrospinal fluid, so the responses from the central nervous system will be improved.

(2) The cardiovascular system: Negative ions can induce vasodilation, prevent cramping of the arterial blood vessels, and lower the blood pressure. These ions can also improve the cardiac functions and muscles of heart disease patients.

(3) The blood circulation system: Negative ions can slow down the blood circulation, delay the hemaglutination, so the oxygen content in the blood will be increased and the risks of blood clotting will be reduced.

(4) The respiratory system: these ions pass through the throat and increase the sweeping action of the tiny hairs in the throat, and improve the mucus flow. Negative ions also enter the blood through the alveolar epithelium to negatively charge the red blood cells increasing the proteometabolism, so the lung capacity of a person can be increased.

Since inhaling negative ions have so many benefits, many artificial ionizers are available on the market, which users can choose to install in their offices and homes, so as to generate cleaner air in the living environment. However, these ionizers have to be placed in certain positions, and certain conditions have to be met, in order to generate negative ions with good results.

In accordance with the present invention, the vibrating member of a loud speaker installable in a portable device, such as a telephone, hand held phone, walkman, car audio, or digital audio device, allows negative ions to be distributed wherever and whenever the user brings along the portable device.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a schematic diagram of the fabrication of a speaker vibrating member in accordance with the present invention;

FIG. 2 is a perspective view of a spider;

FIG. 3 is a plan view of a diaphragm and a baffle gasket in a loud speaker; and

FIG. 4 is an enlarged diagram of the structure on a fabric sheet suitable for making speaker vibrating member.

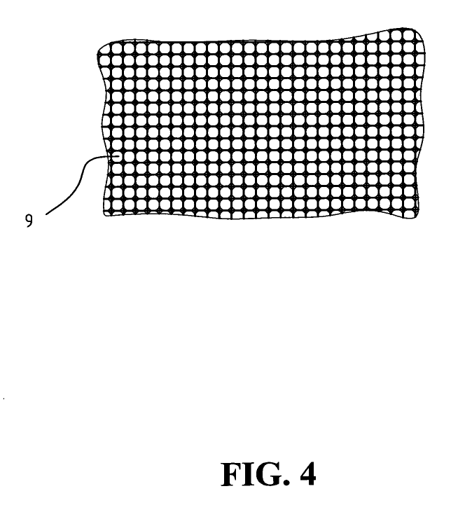

### DETAILED DESCRIPTION OF THE PREFERRED EMBODIMENT

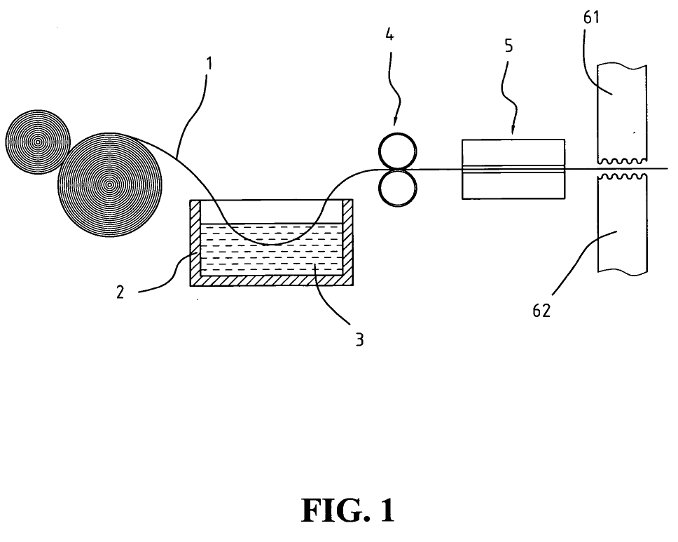

Referring to FIG. 1, the vibration members is a concentric dish/ring in a loud speaker made from cloth, paper or other fabric materials, which can generate negative ions in the air.

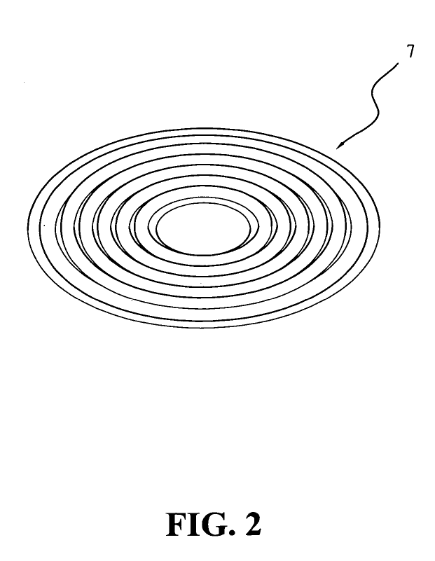

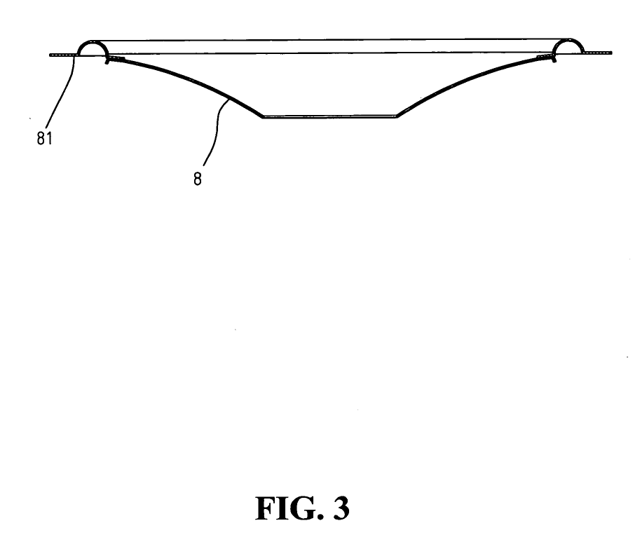

In the fabrication of speaker vibrating member, a fabric roll 1 for making the vibrating member is dipped into a solution holder 2 containing negative ion, which is prepared with copolymerized elastomer 3 and enriched with negative ions, preferably using nanoparticles, and then the soaked fabric sheet 9 after acquiring negative ions is passed through a pair of rollers 4 to spread the elastomer evenly and thoroughly over the fabric material, and then the fabric sheet 9 is passed through a heating element 5 to dry the fabric sheet 9 possesses the required resilience and tenacity, and then the fabric sheet 9 is placed in a press mould having two complementary mould halves 61, 62, which are combined to produce a vibrating member with required shape and structure, such as a spider 7 (shown in FIG. 2), a diaphragm, or a baffle gasket (shown in FIG. 3).

The materials suitable for generating negative ions are tourmaline, raw moonstone, salt crystal rocks, healstones and activated nanoparticles of composite minerals, wherein the composite mineral materials are added with special catalysts and activation agents to increase the concentration with extra negative ions.

Tourmaline possesses unique thermal and piezoelectric characteristics making it ideal for speaker vibrating members. The vibration of the diaphragm and spider in the loud speaker will cause electric charges to be released when enough pressure is exerted so as to generate negative ions in the surrounding air.

In accordance with the present invention, the vibrating member of a loud speaker installable in a portable device, such as a telephone, hand held phone, walkman, car audio, or digital audio device, allows negative ions to be distributed wherever and whenever the user brings along the portable device. If the user talks over a regular telephone or hand phone, the hand set will release negative ions into surrounding air, so the user will be able to breathe fresh air. Likewise, if the user plays audio in a car or at home, the amplifier will release negative ions to make the room more refreshing and invigorating.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A speaker vibrating member, comprising a concentric dish/ring in a loud speaker that contains special material to generate negative ions in the air.

2. The speaker vibrating member as claimed in claim 1, wherein the special material comprises organic non-metal powder obtained from natural minerals.

3. The speaker vibrating member as claimed in claim 1, wherein the vibrating member is made of cloth.

4. The speaker vibrating member as claimed in claim 1, wherein the vibrating member is made of paper.

5. The speaker vibrating member as claimed in claim 1 wherein the vibrating member is formed in the shape of a spider.

6. The speaker vibrating member as claimed in claim 1, wherein the vibrating member is formed in the shape of a diaphragm.

7. The speaker vibrating member as claimed in claim 1, wherein the vibrating member is formed in the shape of a baffle gasket.
